(19) United States
(12) Patent Application Publication
(10) Pub. No.: US 2026/0154180 A1
(43) Pub. Date: Jun. 4, 2026

(54) APPARATUS FOR ANALYZING EVENT LOG, METHOD OF ANALYZING SAME, AND VEHICLE OR SERVER INCLUDING SAME

(71) Applicants: Hyundai Motor Company, Seoul (KR); Kai Corporation, Seoul (KR)

(72) Inventor: Pyoung Hwa Lee, Hwaseong-Si (KR)

(21) Appl. No.: 19/230,365

(22) Filed: Jun. 6, 2025

(30) Foreign Application Priority Data
Dec. 4, 2024 (KR) 10-2024-0178458

(51) Int. Cl. G06F 11/362

(52) U.S. Cl. CPC G06F 11/362

(57) ABSTRACT

An apparatus for a vehicle may comprise a processor and a memory storing at least one instruction that, when executed by the processor communicating with the memory, is configured to cause the apparatus to receive event log files associated with an operation of the vehicle, extract function information from the event log files, determine, based on the function information, a function call relation tree for the event log files, generate, based on the function information and the function call relation tree, error information, output, based on the error information, a signal indicating to perform a debugging to correct at least one error associated with the operation of the vehicle, and cause, based on the signal, performance of the operation of the vehicle.

### CROSS-REFERENCE TO RELATED APPLICATION(S)

The present application claims the benefit of priority under 35 U.S.C. 119 to Korean Patent Application No. 10-2024-0178458, filed on Dec. 4, 2024, in the Korean Intellectual Property Office, the entire contents of which are herein incorporated by reference.

### 1. FIELD

The present disclosure is related to technology for analyzing an event log and, more particularly, to an apparatus for reducing time and effort to analyze a log related to a task or an event generated in a system, a method of analyzing the same, and a vehicle or a server including the same.

### 2. BACKGROUND

The matters described in this Background section are only for enhancement of understanding of the background of the disclosure, and should not be taken as acknowledgment that they correspond to prior art already known to those skilled in the art.

An error event may be generated while a task or a system is executed, and a device (or system) for storing function call information at a time point at which the error event is generated as a log file and analyzing the stored log files is implemented.

For example, in the vehicle field, the event log analysis device may be mounted to a vehicle terminal or a server (vehicle server) that provides a vehicle-related service.

When a large number of event log files are accumulated in a terminal or a server, it may take a lot of time and effort to analyze the event log files.

Accordingly, a method capable of reducing the time and effort required to analyze a large number of event log files is considered.

### SUMMARY

According to the present disclosure, an apparatus for a vehicle, the apparatus may comprise, a processor, and a memory storing at least one instruction that, when executed by the processor communicating with the memory, is configured to cause the apparatus to, receive event log files associated with an operation of the vehicle, extract function information from the event log files, determine, based on the function information, a function call relation tree for the event log files, generate, based on the function information and the function call relation tree, error information, output, based on the error information, a signal indicating to perform a debugging to correct at least one error associated with the operation of the vehicle, and cause, based on the signal, performance of the operation of the vehicle.

The apparatus, wherein the function call relation tree indicates a relationship among a plurality of functions associated with at least one event of the vehicle, and wherein the at least one instruction, when executed by the processor communicating with the memory, is configured to cause the apparatus to, generate error information for each function of the plurality of functions, and generate, based on the error information for each function, a corresponding binary file.

The apparatus, wherein the at least one instruction, when executed by the processor communicating with the memory, is configured to cause the apparatus to process each of the event log files to extract function call relation information and function-binary file matching relation information.

The apparatus, wherein the at least one instruction, when executed by the processor communicating with the memory, is configured to cause the apparatus to generate, based on the function call relation information, the function call relation tree.

The apparatus, wherein the at least one instruction, when executed by the processor communicating with the memory, is configured to cause the apparatus to generate the function call relation tree by, determining, for each function of a plurality of functions associated with at least one event of the vehicle, a number of times the function is called across all of the event log files, and associating each function with the corresponding number of calls.

The apparatus, wherein the at least one instruction, when executed by the processor communicating with the memory, is configured to cause the apparatus to, process each of the event log files to extract event generation time information, determine, based on the extracted event generation time information, a function call relation for each event log file, and generate a function call relation tree for each of the determined function call relations.

The apparatus, wherein the at least one instruction, when executed by the processor communicating with the memory, is configured to cause the apparatus to, process each of the event log files to extract software version information, determine a function call relation for each event log file based on the extracted software version information, and generate a function call relation tree for each of the determined function call relations.

The apparatus, wherein the at least one instruction, when executed by the processor communicating with the memory, is configured to cause the apparatus to generate error information for functions other than an entry function, based on the function information and the function call relation tree.

The apparatus, wherein the error information may comprise, a function, a number of times the function is called across all of the event log files, and binary file information associated with the function.

The apparatus, wherein the at least one instruction, when executed by the processor communicating with the memory, is configured to cause the apparatus to, obtain the number of times from the function call relation tree, and obtain the binary file information from the function information.

The apparatus, wherein the at least one instruction, when executed by the processor communicating with the memory, is configured to cause the apparatus to generate the error information for each binary file based on, a number of calls for each function included in the error information for each function, and preset function-binary file matching relation information.

The apparatus, wherein the at least one instruction, when executed by the processor communicating with the memory, is configured to cause the apparatus to aggregate, based on the function-binary file matching relation information, the number of calls for each function associated with a binary file into a count value for the binary file.

The apparatus, wherein the at least one instruction, when executed by the processor communicating with the memory, is configured to cause the apparatus to set a counter value for each binary file, wherein the counter value is obtained by summing the number of calls for each function associated with the binary file.

The apparatus, wherein the apparatus is mounted in the vehicle or a server configured to provide a service to the vehicle.

The apparatus, wherein events corresponding to the event log files comprise at least one crash of software executed in the vehicle.

According to the present disclosure, a method performed by an apparatus of a vehicle, the method may comprise, receiving event log files associated with an operation of the vehicle, extracting function information from the event log files, determining, based on the function information, a function call relation tree for the event log files, generating, based on the function information and the function call relation tree, error information, outputting, based on the error information, a signal indicating to perform a debugging to correct at least one error associated with the operation of the vehicle, and performing, based on the signal, the operation of the vehicle.

According to the present disclosure, an apparatus of a vehicle, the apparatus may comprise, a processor, and a memory storing at least one instruction that, when executed by the processor communicating with the memory, is configured to cause the apparatus to, obtain a plurality of event log files generated by executable codes executed in the vehicle, process the plurality of event log files to detect one or more executable codes associated with an error, generate error information for the one or more detected executable codes, wherein the error information may comprise a reference to a corresponding executable code to be updated, correct the error by updating the corresponding executable code, and control, using the updated executable code, at least one operation of the vehicle.

The apparatus, wherein the at least one instruction that, when executed by the processor communicating with the memory, is configured to cause the apparatus to process the plurality of event log files by, generating, based on sequences of function calls recorded in the plurality of event log files, a function call relation tree, and associating a call count with each function in the function call relation tree.

The apparatus, wherein the error information may comprise a binary file in which each of the one or more detected executable codes is stored.

The apparatus, wherein the corresponding executable code is updated based on a determination that a call count for the detected executable code exceeds a preset threshold.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE DRAWINGS

The accompanying drawings are to help understanding of examples of the present disclosure, and detailed description is provided along with the examples. However, technical features of the example are not limited to specific drawings, and features shown in each drawing may be combined with each other and configured as a new example.

FIG. 1 shows an example of a configuration of an example of an event log analysis system according to an example of the present disclosure.

FIG. 2 shows an example of a configuration of another example of the event log analysis system according to an example of the present disclosure.

FIG. 3 shows an example of a configuration of an event monitoring device according to an example of the present disclosure.

FIG. 4 shows an example of a function call relation tree generated based on [Table 1].

FIG. 5 shows an example of a configuration of an event log analysis device according to an example of the present disclosure.

FIG. 6 shows an example of an event log file analysis method of the event log analysis device according to an example of the present disclosure.

### DETAILED DESCRIPTION

In describing the examples set forth herein, a detailed description of known functions or configurations incorporated herein will be omitted when it is determined that the description may make the subject matter of the examples set forth herein unclear. In addition, it should be appreciated that the accompanying drawings are provided only for the sake of easy understanding of the examples set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” are intended to specify the existence of mentioned features, numbers, steps, elements, operations, components, or combinations thereof, and should be construed as not precluding the possible existence or addition of one or more other features, numbers, steps, operations, elements, components, or combinations thereof. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure. In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

Hereinafter, examples set forth herein will be described in detail with reference to the accompanying drawings, and the same or similar elements are given the same and similar reference numerals regardless of figure numbers, so duplicate descriptions thereof will be omitted.

According to the present disclose a method and an apparatus are introduced for analyzing a relatively large amounts of crash logs generated by software running in vehicles. Each crash log may contain a list of function calls made before the crash occurred. When large volumes of these logs accumulate-especially across many devices—it becomes difficult and time-consuming to manually analyze each one. The proposed method may solve this by merging multiple function call sequences into a weighted tree structure, where each node represents a function and its call frequency. By combining overlapping function paths, it may reduce redundancy and highlights which functions appear most frequently in crash scenarios. It also organizes this information by time periods (like and software versions, allowing morning or night) pinpointing problematic functions and modules more effectively. Such approach may enable faster debugging, pattern recognition across logs, and improved software stability for safe and reliable operations of a vehicle (e.g., autonomous driving of a vehicle).

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of crash log aggregation and analysis for efficient debugging of frequently involved software functions in a vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of crash log aggregation and analysis for efficient debugging of frequently involved software functions in a vehicle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of crash log aggregation and analysis for efficient debugging of frequently involved software functions in a vehicle) described herein.

Minimum risk maneuver (MRM) operation(s) may also be controlled, for example, based on one or more features (e.g., features of crash log aggregation and analysis for efficient debugging of frequently involved software functions in a vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of crash log aggregation and analysis for efficient debugging of frequently involved software functions in a vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of crash log aggregation and analysis for efficient debugging of frequently involved software functions in a vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

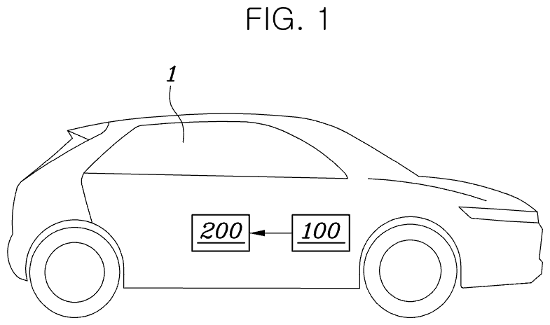

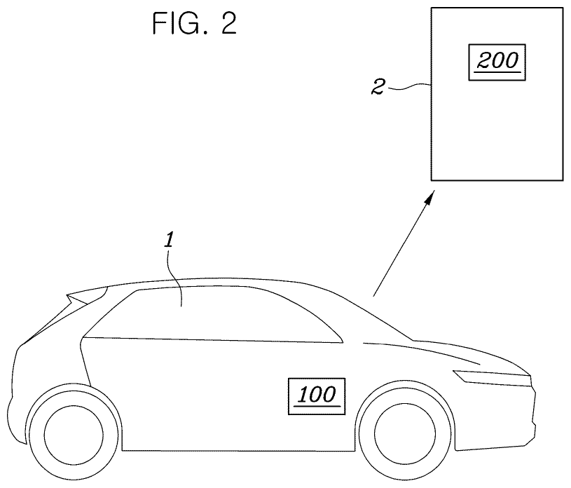

FIG. 1 shows an example of a configuration of an example of an event log analysis system according to an example of the present disclosure, and FIG. 2 shows an example of a configuration of another example of the event log analysis system according to an example of the present disclosure.

The event log analysis system according to an example of the present disclosure may be implemented to analyze an event generated in various types of electronic devices. For example, the electronic device may include a vehicle, a mobile electronic device, a mobile communication device, a smart home appliance, a wearable computing device, an Internet of things (IoT) device, an entertainment device, a notebook computer, a desktop computer, a server, a robotic platform, or an industrial control system, etc.

The event log analysis system may be implemented to detect an event (ex, crash) generated in software (ex, task software, OS software, autonomous driving software, or system middleware, etc.) executed by the electronic device, store log files for the generated event, express functions in a tree structure, based on the call relation within a plurality of stored log files, and then preferentially analyze a source file of functions having the call relation of a relatively high incidence rate and effectively detect an event generation cause.

Hereinafter, the application of the event log analysis system to a vehicle field is described as an example.

The event log analysis system may include an event monitoring device 100 and an event log analysis device 200, and the configuration of the event log analysis system is not limited thereto.

For example, the event monitoring device 100 may be mounted to a vehicle 1. For example, the event monitoring device 100 may be mounted to a terminal module within the vehicle 1, such as a telematics control circuit, an infotainment head circuit, a powertrain control circuit, or a gateway circuit, but is not limited thereto.

For example, the event log analysis device 200 may be mounted to the vehicle 1 (FIG. 1) or may be mounted to a server (or vehicle server) 2 that provides a service related to the vehicle 1 (FIG. 2), such as fleet diagnostics, over-the-air software updates, or remote debugging services.

### Event Monitoring Device 100

According to an example, the event monitoring device 100 may monitor an execution state of software or an operation system (OS) executed within the vehicle 1, and the like, and when a preset event is generated, may generate a log file related to the event and store the event log file.

For example, the event monitoring device 100 may match event-related function call relation information, generation time information, software version information, function-binary file matching relation information, and the like and generate the event log file.

For example, when a crash occurs while software or the OS is executed, the event monitoring device 100 may generate and store log files, and the preset event is not limited to the occurrence of crash.

For example, software executed in the vehicle 1 may include various types of software such as driving/regenerative braking output limit software, battery management software, motor driving software, airbag control software, and brake control software executed by various controller (e.g., an HCU, ECU, or VCU, etc.). For example, the various types of software may further include power distribution software, steering assist software, adaptive cruise control software, lane keeping assist software, parking assistance software, sensor fusion software, autonomous emergency braking (AEB) software, object detection software, path planning software, environment perception software, or over-the-air (OTA) update software, etc.

For example, software executed in the vehicle 1 may include software, an OS, and the like executed in the terminal to implement vehicle infotainment.

For example, the controller may include a hybrid control unit (HCU), an electronic control unit (ECU), a vehicle control unit (VCU), a motor control unit (MCU), an engine control unit (ECU), a clutch control unit (CCU), a transmission control unit (TCU), a battery management system (BMS), a lidar perception controller, or an ADAS domain controller, and the like, but is not limited thereto.

According to an example, the event monitoring device 100 may transmit event log files to the event log analysis device 200 at a preset time point.

For example, the event monitoring device 100 may transmit event log files to the event log analysis device 200 when the vehicle 1 is turned off, for example, when a diagnostic session is initiated, when a fault threshold is exceeded, or during a scheduled data upload window. But the time point at which the event monitoring device 100 transmits the event log files is not limited thereto.

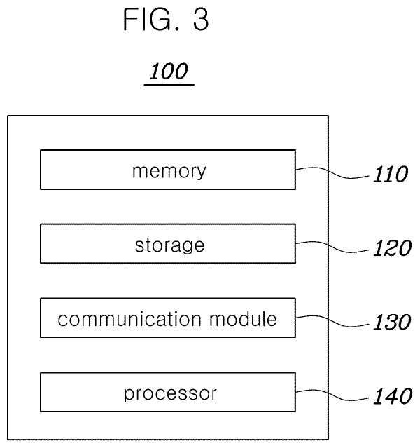

FIG. 3 shows an example of a configuration of the event monitoring device 100 according to an example of the present disclosure.

Referring to FIG. 3, the event monitoring device 100 may include a memory 110, a storage 120, a communication module 130, and a processor 140, but the configuration of the event monitoring device 100 is not limited thereto.

The memory 110 may store algorithms (or programs or software), data, and the like for performing the operation of the event monitoring device 100.

The storage 120 may store information and the like acquired during a process in which the event monitoring device 100 operates. For example, the storage 120 may store event log files, diagnostic results, version history logs, or software execution traces, etc.

For example, the memory 110 and the storage 120 may be implemented as one or more storage media among storage media (or recording media) such as a flash memory, a hard disk, a secure digital (SD) card, a random access memory (RAM), a static random memory (SRAM), a read only memory (ROM), a programmable read only memory (PROM), an electrically erasable and programmable ROM (EEPROM), an erasable and programmable ROM (EPROM), a register, a removable disk, non-volatile memory express (NVMe) storage, or web storage.

The communication module 130 may perform communication between the event monitoring device 100 and an external device. For example, the communication module 130 may include a communication circuit configured to communicate with the event log analysis device 200.

For example, when the event log analysis device 200 is implemented in the vehicle 1, the communication module 130 may communicate with the event log analysis device 200, via a vehicle network.

For example, as the vehicle network, a controller area network (CAN), a local interconnect network (LIN), FlexRay, Ethernet, media-oriented systems transport (MOST), or a time-sensitive networking (TSN) protocol, and the like may be used, but the vehicle network is not limited thereto.

For example, when the event log analysis device 200 is implemented in the server 2, the communication module 130 may communicate with the event log analysis device 200, using a wireless communication network.

For example, as the wireless communication network, a wireless Internet technology such as a wireless LAN (WLAN) (WiFi), wireless broadband (Wibro), and/or world interoperability for microwave access (Wimax), and/or a mobile communication technology such as code division multiple access (CDMA), a global system for mobile communication (GSM), long term evolution (LTE), LTE-advanced, and/or international mobile telecommunication (IMT)-2000, 5G New Radio (NR), or satellite-based vehicle connectivity. And the wireless communication network is not limited to the mentioned communication technologies.

The processor 140 may perform the overall operation of the event monitoring device 100 and may operate based on algorithms/data stored in the memory 110, information stored in the storage 120, and the like.

The processor 140 may be a data processing device implemented in hardware including a circuit having a physical structure for performing desired operations. For example, the desired operations may include code included in programs or instructions.

For example, the data processing device implemented in hardware may include a microprocessor, a central processing unit, a processor core, a multi-core processor, a multiprocessor, an application-specific integrated circuit (ASIC), and a field programmable gate array (FPGA), a system-on-chip (SoC), or a neural processing unit (NPU), etc.

### Event Log Analysis Device 200

According to an example, the event log analysis device 200 may be mounted to the vehicle 1 (FIG. 1) or may be mounted to the server 2 that provides services related to the vehicle 1 (FIG. 2), such as remote diagnostics, over-the-air updates, or fleet analytics services, etc.

The event log analysis device 200 may receive event log files transmitted from the event monitoring device 100 and analyze the received event log files.

For example, a parsing analysis scheme may be applied to the analysis of the event log files, such as string-based parsing, syntax-based parsing, token extraction, pattern-based filtering, or structured log decoding, but is not limited thereto.

According to an example, the event log analysis device 200 may extract function information for each event log file, based on an analysis for each event log file and store the extracted function information for each event log file.

For example, the event log analysis device 200 may analyze event log files and extract function call relation information, event generation time information, software version information, function-binary file matching relation information, execution timestamps, function nesting depth, memory usage statistics, thread or process identifiers, CPU core UDs, fault codes, or hardware context identifiers, etc.

[Table 1] shows an example of function information extracted through analysis of log files for four events by the event log analysis device 200.

TABLE 1

| | | Event |
|---|---|---|
| | | generation |
| | Function call relation | time |
| Event #1 | main( ) −> func1( ) −> func2( ) −> | 2024 Aug. 12 |
| | func3( ) −> func4( ) | 12:20 |
| Event #2 | main( ) −> func1( ) −> func5( ) −> | 2024 Aug. 13 |
| | func6( ) −> func7( ) | 22:20 |
| Event #3 | main( ) −> func1( ) −> func2( ) −> | 2024 Aug. 23 |
| | func6( ) −> func8( ) | 07:20 |
| Event #4 | main( ) −> func1( ) −> func5( ) −> | 2024 Aug. 23 |
| | func3( ) −> func4( ) | 07:20 |

According to an example, the event log analysis device 200 may analyze functions called at the same level, based on function call relation information included in the function information, and determine the number of calls of the corresponding function (or a count value). Further, the event log analysis device 200 may match the function and the number of calls, and generate a tree for the function call relation (a function call relation tree), such as a weighted call graph, a hierarchical function map, or a compressed trace tree, etc., where overlapping paths are merged and weights are assigned to indicate frequency of occurrence.

Accordingly, the event log analysis device 200 may generate a function call relation tree in which the function and the number of calls are structured for each level, enabling identification of frequently invoked branches, performance-critical call paths, or call sequences during software crashes or malfunctions.

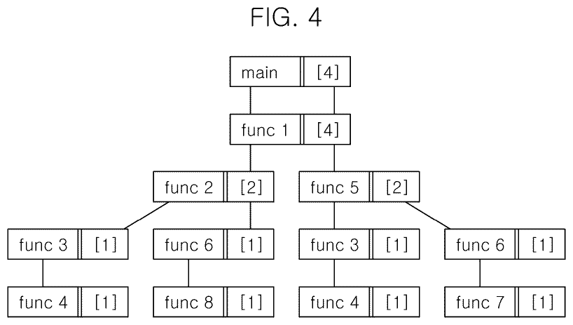

FIG. 4 shows an example of a function call relation tree generated based on [Table 1].

For example, the event log analysis device 200 may generate a function call relation tree as shown in FIG. 4, based on the function information in [Table 1].

As shown in FIG. 4, the event log analysis device 200 may generate a quad tree, based on the function information in [Table 1], and each node of the tree may include a function and the number of calls, such as func1 with a call count of 4 or func2 with a call count of 2, etc.

For example, the event log analysis device 200 may divide the function call relation, based on an event generation time extracted from the function information and generate a tree for each of the divided function call relations.

For example, the event log analysis device 200 may divide the function call relation according to the day, the week, the month, or the like. For example, the event log analysis device 200 may divide the function call relation according to a time period such as time to leave for work, time to leave from work, daytime, late night, weekend hours, or holidays, etc.,

Of course, the reference for dividing the function call relation is not limited to the event generation time. For example, the event log analysis device 200 may divide the function call relation, based on a software version extracted from the function information, such as v1.2.0, v2.0.1, or a beta release version, etc.

According to an example, the event log analysis device 200 may generate error information of the remaining functions except for an entry function (main), based on the function call relation tree and the function information, to identify non-root functions that are statistically more correlated with faults.

According to an example, the error information may include a function, the number of calls for each function (or a count value), and binary file information including the corresponding function. The binary file information may be a name of a binary file (e.g., “libcontrol.so,” “sensor_module.bin,” or “autodrive.dll,” etc.), a module name, a library identifier, or a compiled object file name, etc. The number of calls for each function may be the number of times the corresponding function is called in all of the event log files.

The event log analysis device 200 may arrange error information in the order of the large number (e.g., a highest number) of calls and generate an error information table for each function. For example, when there are functions having the same number of calls, the event log analysis device 200 may arrange the functions, based on a function call level, a function name, timestamp of occurrence, or associated priority weight, alphabetical order, depth in the call hierarchy, or execution frequency under specific operating conditions, etc.

[Table 2] shows an example of an error information table for each function generated for event #1 and event #3.

TABLE 2

| | | Number of | Binary file |
|---|---|---|---|
| Rank | Function | calls (count value) | name |
| 1 | func1( ) | 2 | X |
| 1 | func2( ) | 2 | K |
| 2 | func3( ) | 1 | X |
| 2 | func4( ) | 1 | K |
| 2 | func6( ) | 1 | X |
| 2 | func8( ) | 1 | J |

In [Table 1], event #1 includes a first function (func1), a second function (func2), a third function (func6), and a fourth function (func4) except for the main function (main), and event #3 includes a first function (func1), a second function (func2), a sixth function (func6), and an eighth function (func8) except for the main function (main), which serves as the entry point.

When event #1 and event #3 are combined, the first function (func1) and the second function (func2) are called twice, and each of the third function (func3), the fourth function (func4), the sixth function (func6), and the eighth function (func8) are called once, indicating their lower relative contribution to crash frequency.

Further, the function-binary file matching relation is preset when a program is generated, and it is assumed that the first function (func1), the third function (func3), and the sixth function (func6) match a binary file X, the second function (func2) and the fourth function (func4) match a binary file K, and the eighth function (func8) matches a binary file J, which may correspond to software modules such as communication stacks, control routines, or diagnostic handlers, etc.

Accordingly, the event log analysis device 200 may generate the error information table for each function in [Table 2] for event #1 and event #3 in [Table 1], to show function-level involvement across multiple events.

According to an example, after generating the error information table for each function, the event log analysis device 200 may integrate (convert) the number of calls for each function included in the error information table for each function into a count value for each binary file and generate error information for each binary file, such as for the purpose of binary-level fault prioritization.

Further, the event log analysis device 200 may arrange the error information for each binary file in the order of a large count value and generate an error information table for each binary file, facilitating ranking of fault-prone binaries.

According to an example, the event log analysis device 200 may add all of the numbers of calls related to the function that matches the binary file and configure the result as a count value of the binary file, which reflects the aggregate fault contribution of that binary.

According to an example, the error information table for each binary file may include a count value for each binary file, a corresponding list of matched functions, a module type identifier (e.g., control, UI, or safety), or a software version tag, etc.

[Table 3] shows an example of an error information table for each binary file generated for [Table 2].

TABLE 3

| Rank | Binary file name | Count value |
|---|---|---|
| 1 | X | 4 |
| 2 | K | 3 |
| 3 | J | 1 |

In [Table 2], the binary file X matches the first function (func1), the third function (func3), and the sixth function (func6), the number of calls of the first function (func1) is 2, the number of calls of the third function (func3) is 1, and the number of calls of the sixth function (func6) is 1, which may indicate, for example, frequent involvement of control logic, state transition handlers, or scheduling routines, etc. The binary file K matches the second function (func2) and the fourth function (func4), the number of calls of the second function (func2) is 2, and the number of calls of the fourth function (func4) is 1, for example, suggesting moderate activity in components such as sensor interfaces, data formatters, or command dispatchers, etc. The binary file J matches the eighth function (func8) and the number of calls of the eighth (func8) is 1. Accordingly, a count value of the binary file X may be configured as 4 obtained by adding 2 that is the number of calls of the first function (func1), 1 that is the number of calls of the third function (func3), and 1 that is the number of calls of the sixth function (func6), which may represent, for example, aggregated activity from frequently executed logic such as control loops, initialization routines, or error-handling callbacks, etc. A count value of the binary file K may be configured as 3 obtained by adding 2 that is the number of calls of the second function (func2) and 1 that is the number of calls of the fourth function (func4). A count value of the binary file J may be configured as 1 that is the number of calls of the eighth function (func8), which may correspond to less frequently involved components such as utility libraries, communication handlers, or diagnostic reporting modules, etc.

Accordingly, the event log analysis device 200 may generate the error information table for each binary file in [Table 3], based on the error information table for each function in [Table 2], in order to aggregate fault metrics at the binary level for ranking or prioritization.

According to an example, the event log analysis device 200 may provide a user with generated information, that is, the function call relation tree (FIG. 4), the error information table for each function (Table 2), and the error information table for each binary file (Table 3), to support debugging, visualization, or automated triage operations.

For example, the event log analysis device 200 may provide the same to a preset device. For example, the preset device may include a vehicle terminal, a user terminal for analysis, a remote server dashboard, a diagnostic tool interface, or a continuous integration (CI) system, etc.

According to an example, when the event log analysis device 200 is mounted to the vehicle 1, the event log analysis device 200 may include a display module and output information to the display module, such as a touchscreen panel, instrument cluster display, or head-up display (HUD), etc.

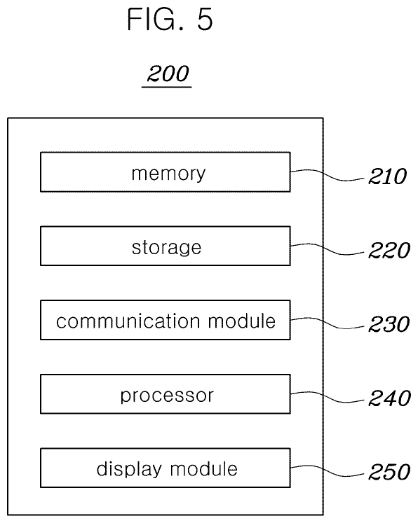

FIG. 5 shows an example of a configuration of the event log analysis device 200 according to an example of the present disclosure.

Referring to FIG. 5, the event log analysis device 200 include a memory 210, a storage 220, a communication module 230, and a processor 240, but the configuration of the event log analysis device 200 is not limited thereto. According to an example, the event log analysis device 200 may further include a display module 250, a debugging interface, a system diagnostics controller, or a remote update handler, etc.

The memory 210 may store algorithms (or programs or software), data, and the like for performing the operation of the event log analysis device 200, such as function call parsers, tree-building logic, error ranking procedures, or timestamp correlation tools, etc.

The storage 220 may store information and the like acquired during a process in which the event log analysis device 200 operates. For example, the storage 220 may store a function call relation tree, an error information table for each function, an error information table for each binary file, and the like generated by the event log analysis device 200, as well as historical data snapshots, intermediate analysis results, or event trace archives, etc.

For example, the memory 210 and the storage 220 may be implemented as one or more storage media among storage media (or recording media) such as a flash memory, a hard disk, a secure digital (SD) card, a random access memory (RAM), a static random memory (SRAM), a read only memory (ROM), a programmable read only memory (PROM), an electrically erasable and programmable ROM (EEPROM), an erasable and programmable ROM (EPROM), a register, a removable disk, web storage, a solid-state hybrid drive (SSHD), cloud-connected blob storage, or NVMe drive, etc.

The communication module 230 may perform communication between the event log analysis device 200 and an external device. For example, the communication module 230 may include a communication circuit configured to communicate with the event monitoring device 100, a remote diagnostic server, a vehicle control unit, or an external cloud platform, etc.

For example, when the event log analysis device 200 is implemented in the vehicle 1, the communication module 230 may communicate with the event monitoring device 100, based on a vehicle network.

For example, as the vehicle network, a controller area network (CAN), a local interconnect network (LIN), FlexRay, Ethernet, and the like may be used, including variants such as CAN FD, automotive Ethernet AVB, or time-sensitive networking (TSN), but the vehicle network is not limited thereto.

For example, when the event log analysis device 200 is implemented in the server 2, the communication module 230 may communicate with the event monitoring device 100, based on a wireless communication network.

For example, as the wireless communication network, a wireless Internet technology such as a wireless LAN (WLAN) (WiFi), wireless broadband (Wibro), and/or world interoperability for microwave access (Wimax), and/or a mobile communication technology such as code division multiple access (CDMA), a global system for mobile communication (GSM), long term evolution (LTE), LTE-advanced, and/or international mobile telecommunication (IMT)-2000, or other networks such as 5G NR, vehicle-to-everything (V2X), or satellite communication links may be used, and the wireless communication network is not limited to the mentioned communication technologies.

The processor 240 may perform the overall operation of the event log analysis device 200 and may operate based on algorithms/data stored in the memory 210, information stored in the storage 220, and the like.

The processor 240 may be a data processing device implemented in hardware including a circuit having a physical structure for performing desired operations. For example, the desired operations may include code included in programs or instructions, such as weighted tree construction, data clustering, or error pattern classification.

For example, the data processing device implemented in hardware may include a microprocessor, a central processing unit, a processor core, a multi-core processor, a multiprocessor, an application-specific integrated circuit (ASIC), and a field programmable gate array (FPGA), a graphics processing unit (GPU), a neural processing unit (NPU), or a system-on-chip (SoC), etc.

The display module 250 may output information provided from the processor 240. For example, the display module 250 may output a function call relation tree, an error information table for each function, an error information table for each binary file, and the like provided from the processor 240, in graphical form such as hierarchical trees, ranked tables, or time-aligned event timelines.

For example, the display module 250 may include at least one of a liquid crystal display (LCD), a thin film transistor-liquid crystal display (TFT LCD), an organic light-emitting diode (OLED), a flexible display, and a 3D display, a head-up display (HUD), an instrument cluster screen, or an in-cabin infotainment panel, etc.

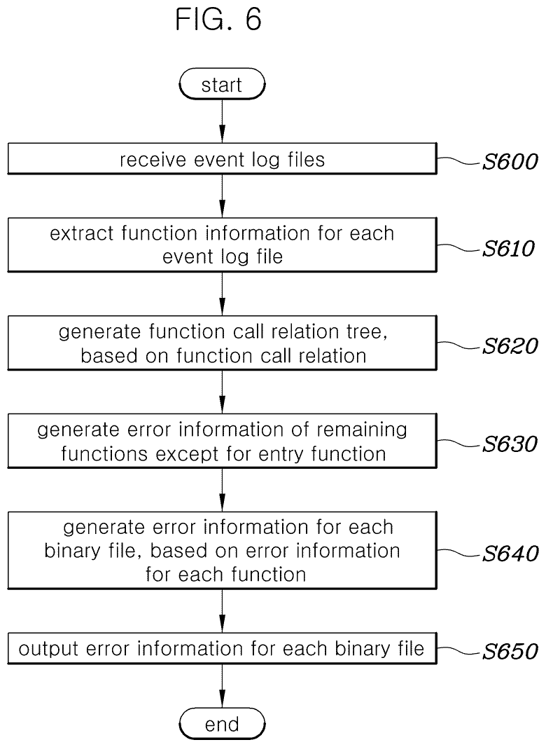

FIG. 6 shows an example of an event log file analysis method of the event log analysis device 200 according to an example of the present disclosure.

The operation at each step shown in FIG. 6 may be performed by the event log analysis device 200 described with reference to FIG. 1, FIG. 2, FIG. 3, FIG. 4, and FIG. 5, which collectively describe both vehicle-side and server-side implementations.

Referring to FIG. 6, the event log analysis device 200 may receive event log files from the event monitoring device 100 in S600, via a wired or wireless communication interface, based on a scheduled transmission trigger, a shutdown event, or a diagnostic command, etc.

The event log analysis device 200 may analyze event log files, based on a parsing analysis scheme or the like and extract function information for each event log file in S610, such as by using syntax-aware parsers, pattern matchers, or rule-based tokenizers, etc.

According to an example, the event log analysis device 200 may extract, for each event log file, function call relation information, event generation time information, software version information, function-binary file matching relation information, and the like, including optional metadata such as thread ID, execution context, or exception codes, etc.

Thereafter, the event log analysis device 200 may generate a function call relation tree, based on function call relation information of the function information for each event log file in S620, to represent hierarchical or sequential execution patterns.

According to an example, the event log analysis device 200 may analyze functions called at the same level, based on function call relation information included in the function information, and the number of times the corresponding function is called in all of the event log files (or a count value), which may serve as a quantitative indicator of recurring behavior.

Further, the event log analysis device 200 may match the function and the number of calls, arrange information on the function-number of calls according to a call level of the function, and generate a function call relation tree, where overlapping call paths are merged to reduce redundancy and highlight frequently invoked branches.

According to an example, each node in the function call relation tree may include a function and the number of calls, optionally annotated with time range, call depth, or fault correlation scores, etc.

For example, the event log analysis device 200 may divide the function call relation, based on the event generation time extracted from the function information and generate a function call relation tree for each of the divided function call relations, such as for morning, evening, or specific operating cycles, etc.

For example, the event log analysis device 200 may divide the function call relation, based on the software version extracted from the function information and generate a function call relation tree for each of the divided function call relations, such as for A/B testing of releases, nightly builds, or pre-production firmware, etc. A/B testing of releases refers to a method where different software versions are deployed to compare performance or error rates, helping identify the more reliable version before full rollout.

Thereafter, the event log analysis device 200 may generate error information of the remaining functions except for an entry function, based on the function call relation tree and the function information in S630. For example, the error information may include a function, the number of calls for each function, and binary file information including the corresponding function, to help correlate errors to compiled software components.

In the error information, the function and the number of calls of the function may be acquired from the function relation tree, and the binary file information may be acquired from the function-binary file matching relation information included in the function information.

Further, the event log analysis device 200 may generate an error information table for each function, based on the generated error information (see [Table 2]), to rank functions based on recurrence and relevance.

Thereafter, the event log analysis device 200 may generate error information for each binary file, based on the error information for each function in S640, for example, by aggregating the involvement of functions linked to each binary.

According to an example, the event log analysis device 200 may integrate the number of calls for each function included in the error information for each function into a count value for each binary file and generate error information for each binary file, such as to support binary-level fault prioritization, patch planning, or codebase refactoring.

The event log analysis device 200 may generate an error information table for each binary file, based on the error information for each binary file (see [Table 3]), for example, sorted in descending order of contribution to recurring events.

According to an example, the event log analysis device 200 may add the number of calls of the function that matches each binary file, based on the error information for each function, and configure the result as a binary file count value, for example, reflecting cumulative function-level impact within each binary.

Thereafter, the event log analysis device 200 may output the error information for each binary file in S650, for display, transmission, or downstream automated analysis, such as predictive maintenance or OTA patch targeting.

The present disclosure has been made in order to solve the above-mentioned problems and an example of the present disclosure is to provide an event log analysis apparatus, a method of analyzing the same, and a vehicle or a server including the same capable of efficiently analyzing event log files and reducing time and effort spent for analyzing the event log files.

Another example of the present disclosure is to provide an event log analysis apparatus, a method of analyzing the same, and a vehicle or a server including the same suitable for analyzing a large number of log files including function call information.

Another example of the present disclosure is to provide an event log analysis apparatus, a method of analyzing the same, and a vehicle or a server including the same implemented to easily detect a function causing the problem during analysis by expressing a plurality of function call relations as a tree structure.

The technical subjects pursued in the present disclosure may not be limited to the above-mentioned technical subjects, and other technical subjects which are not mentioned may be clearly understood from the following descriptions by those skilled in the art to which the present disclosure pertains.

In accordance with an example of the present disclosure, an event log analysis apparatus according to an example of the present disclosure is an event log analysis apparatus for analyzing a log related to an event generated in an electronic device. The event log analysis apparatus may receive event log files from an event monitoring device, extract function information from each of the event log files, generate a function call relation tree for all of the event log files, based information, and generate error on the function information for each function, based on the function information and the function call relation tree.

According to an example of the present disclosure, the event log analysis apparatus may generate error information for each binary file, based on the error information for each function.

According to an example of the present disclosure, the event log analysis apparatus may extract function call relation information and function-binary matching relation information by analyzing each of the event log files.

According to an example of the present disclosure, the event log analysis apparatus may generate the function call relation tree, based on the function call relation information.

According to an example of the present disclosure, the event log analysis apparatus may analyze a number of times the function is called in all of the event log files and matches the function and the number of calls, so as to generate the function call relation tree.

According to an example of the present disclosure, the event log analysis apparatus may analyze each of the event log files, further extract event generation time information, divide the function call relation, based on the event generation time information, and generate the function call relation tree for each of the divided function call relations.

According to an example of the present disclosure, the event log analysis apparatus may analyze each of the event log files, further extract software version information, divide the function call relation, based on the software version information, and generate the function call relation tree for each of the divided function call relations.

According to an example of the present disclosure, the event log analysis apparatus may generate error information of remaining functions except for an entry function, based on the function information and the function call relation tree.

According to an example of the present disclosure, the error information may include a function, a number of times the function is called in all of the event log files and binary file information that matches the function.

According to an example of the present disclosure, the event log analysis apparatus may acquire the number of times from the function call relation tree and acquire the binary file information from the function information.

According to an example of the present disclosure, the event log analysis apparatus may generate the error information for each binary file, based on a number of calls for each function included in the error information for each function and preset function-binary file matching relation information.

According to an example of the present disclosure, the event log analysis apparatus may integrate the number of calls for each function that matches a binary file into a count value for each binary file, based on the function-binary file matching relation information.

According to an example of the present disclosure, the event log analysis apparatus may configure, as the counter value for each binary file, a value obtained by adding the number of calls for each function that matches the binary file.

According to an example of the present disclosure, the event log analysis apparatus may be mounted in a vehicle or a server for providing a service to the vehicle.

According to an example of the present disclosure, the event may include generation of crash of software executed in a vehicle.

An event log analysis method according to an example of the present disclosure is a method of analyzing a log related to an event generated in an electronic device by using an event log analysis apparatus. The method may include receiving event log files from an event monitoring apparatus, extracting function information from each of the event log files, generating a function call relation tree for all of the event log files, based on the function information, and generating error information for each function, based on the function information and the function call relation tree

A vehicle according to an example of the present disclosure may include an event monitoring apparatus configured to monitor an event generated in the vehicle and an event log analysis apparatus configured to receive event log files provided from the event monitoring device, wherein the event log analysis apparatus may extract function information from each of the event log files, generate a function call relation tree for all of the event log files, based on the function information, and generate error information for each function, based on the function information and the function call relation tree.

A server according to an example of the present disclosure is a server for analyzing a log related to an event generated in a vehicle. The server may include an event log analysis apparatus, wherein the event log analysis apparatus may be configured to receive event log files from the vehicle, extract function information from each of the event log files, generate a function call relation tree for all of the event log files, based on the function information, and generate error information for each function, based on the function information and the function call relation tree.

In addition to the above-mentioned solutions to the technical subjects, detailed particulars according to various examples of the present disclosure are included in the following description and the accompanying drawings.

According to an example of the present disclosure, an event log analysis apparatus and a method of analyzing the same capable of efficiently analyzing event log files can be provided.

According to an example, an event log analysis apparatus and a method of analyzing the same suitable for analyzing a large number of log files including function call information can be provided.

According to an example, it is possible to easily detect a function causing the problem during analyzing because a plurality of function call relations are expressed in a tree structure.

Accordingly, by using the event log analysis apparatus and the method of analyzing the same according to an example of the present disclosure, it is possible to efficiently analyze event log files and reduce time and effort spent for analyzing the event log files.

By applying the event log analysis apparatus and the method of analyzing the same according to an example of the present disclosure to vehicle fields (ex, vehicle terminal or vehicle server), it is possible to efficiently analyze log files related to an event (ex, crash) generated in a task or a system executed in the vehicle and reduce time and effort spent for analyzing the event log files.

Accordingly, it is possible to improve the safety and performance of a vehicle system and improve analysis efficiency of the vehicle system.

Accordingly, the user performing the event log analysis may identify error information for each binary file output by the event log analysis device 200 and preferentially analyze functions included in a binary file having a high priority (that is, a binary file having a high count value).

Therefore, by using the event log analysis device and the analysis method of the same according to an example of the present disclosure, the user may efficiently analyze event log files and reduce time and effort spent for analyzing the event log files.

Although examples of the present disclosure have been described above with reference to the accompanying drawings, the present disclosure is not necessarily limited to these examples and various modifications and changes may be made thereto without departing from the technical idea of the present disclosure. Therefore, the examples set forth herein are not intended to limit the technical idea of the present disclosure but intended to explain the technical idea of the present disclosure, and the scope of the technical idea of the present disclosure is not limited by these examples. Accordingly, the examples as described above should be construed as being exemplary and non-limitative in all examples. The scope of protection of the present disclosure should be de fined by the appended claims, and all technical ideas equivalent to the claims shall be construed as falling within the scope of protection of the present disclosure.

What is claimed:

1. An apparatus for a vehicle, the apparatus comprising:
a processor; and
a memory storing at least one instruction that, when executed by the processor communicating with the memory, is configured to cause the apparatus to:
receive event log files associated with an operation of the vehicle,
extract function information from the event log files,
determine, based on the function information, a function call relation tree for the event log files,
generate, based on the function information and the function call relation tree, error information,
output, based on the error information, a signal indicating to perform a debugging to correct at least one error associated with the operation of the vehicle, and
cause, based on the signal, performance of the operation of the vehicle.

2. The apparatus of claim 1, wherein the function call relation tree indicates a relationship among a plurality of functions associated with at least one event of the vehicle, and wherein the at least one instruction, when executed by the processor communicating with the memory, is configured to cause the apparatus to:
generate error information for each function of the plurality of functions, and
generate, based on the error information for each function, a corresponding binary file.

3. The apparatus of claim 1, wherein the at least one instruction, when executed by the processor communicating with the memory, is configured to cause the apparatus to process each of the event log files to extract function call relation information and function-binary file matching relation information.

4. The apparatus of claim 3, wherein the at least instruction, when executed by the processor one communicating with the memory, is configured to cause the apparatus to generate, based on the function call relation information, the function call relation tree.

5. The apparatus of claim 4, wherein the at least one instruction, when executed by the processor communicating with the memory, is configured to cause the apparatus to generate the function call relation tree by:
determining, for each function of a plurality of functions associated with at least one event of the vehicle, a number of times the function is called across all of the event log files, and
associating each function with the corresponding number of calls.

6. The apparatus of claim 3, wherein the at least one instruction, when executed by the processor communicating with the memory, is configured to cause the apparatus to:
process each of the event log files to extract event generation time information,
determine, based on the extracted event generation time information, a function call relation for each event log file, and
generate a function call relation tree for each of the determined function call relations.

7. The apparatus of claim 3, wherein the at least one instruction, when executed by the processor communicating with the memory, is configured to cause the apparatus to:
process each of the event log files to extract software version information,
determine a function call relation for each event log file based on the extracted software version information, and
generate a function call relation tree for each of the determined function call relations.

8. The apparatus of claim 1, wherein the at least one instruction, when executed by the processor communicating with the memory, is configured to cause the apparatus to generate error information for functions other than an entry function, based on the function information and the function call relation tree.

9. The apparatus of claim 1, wherein the error information comprises:
a function,
a number of times the function is called across all of the event log files, and
binary file information associated with the function.

10. The apparatus of claim 9, wherein the at least one instruction, when executed by the processor communicating with the memory, is configured to cause the apparatus to:
obtain the number of times from the function call relation tree, and
obtain the binary file information from the function information.

11. The apparatus of claim 2, wherein the at least one instruction, when executed by the processor communicating with the memory, is configured to cause the apparatus to generate the error information for each binary file based on:
a number of calls for each function included in the error information for each function, and
preset function-binary file matching relation information.

12. The apparatus of claim 11, wherein the at least one instruction, when executed by the processor communicating with the memory, is configured to cause the apparatus to aggregate, based on the function-binary file matching relation information, the number of calls for each function associated with a binary file into a count value for the binary file.

13. The apparatus of claim 12, wherein the at least one instruction, when executed by the processor communicating with the memory, is configured to cause the apparatus to set a counter value for each binary file, wherein the counter value is obtained by summing the number of calls for each function associated with the binary file.

14. The apparatus of claim 1, wherein the apparatus is mounted in the vehicle or a server configured to provide a service to the vehicle.

15. The apparatus of claim 1, wherein events corresponding to the event log files comprise at least one crash of software executed in the vehicle.

16. A method performed by an apparatus of a vehicle, the method comprising:
receiving event log files associated with an operation of the vehicle;
extracting function information from the event log files;
determining, based on the function information, a function call relation tree for the event log files;
generating, based on the function information and the function call relation tree, error information;
outputting, based on the error information, a signal indicating to perform a debugging to correct at least one error associated with the operation of the vehicle; and
performing, based on the signal, the operation of the vehicle.

17. An apparatus of a vehicle, the apparatus comprising:
a processor; and
a memory storing at least one instruction that, when executed by the processor communicating with the memory, is configured to cause the apparatus to:
obtain a plurality of event log files generated by executable codes executed in the vehicle,
process the plurality of event log files to detect one or more executable codes associated with an error,
generate error information for the one or more detected executable codes, wherein the error information comprises a reference to a corresponding executable code to be updated,
correct the error by updating the corresponding executable code, and
control, using the updated executable code, at least one operation of the vehicle.

18. The apparatus of claim 17, wherein the at least one instruction that, when executed by the processor communicating with the memory, is configured to cause the apparatus to process the plurality of event log files by:
generating, based on sequences of function calls recorded in the plurality of event log files, a function call relation tree; and
associating a call count with each function in the function call relation tree.

19. The apparatus of claim 17, wherein the error information comprises a binary file in which each of the one or more detected executable codes is stored.

20. The apparatus of claim 17, wherein the corresponding executable code is updated based on a determination that a call count for the detected executable code exceeds a preset threshold.
